(19) United States
(12) Patent Application Publication
(10) Pub. No.: US 2004/0008879 A1
(43) Pub. Date: Jan. 15, 2004

(54) Method for detecting wafer level defect

(75) Inventor: Benjamin Szu-Min Lin, Hsin-Chu City (TW)

Correspondence Address: LOWE, HAUPTMAN, GOPSTEIN & BERNER, LLP, Suite 310, 1700 Diagonal Road, Alexandria, VA, 22314, US

(73) Assignee: UNITED MICROELECTRONICS CORP.

(21) Appl. No.: 10/192,539

(22) Filed: Jul. 11, 2002

(51) Int. Cl. G06K 9/00

(52) U.S. Cl. 382/144

(57) ABSTRACT

A method for detecting wafer level defect by die-to-aerial image comparison is disclosed. The method utilizes patterns in a database which are used to form photo masks utilized in photolithography processes to simulate aerial images. The simulation aerial images are then compared with die images produced by the photo masks to find out wafer level defects without missing any repeating defect induced by the photo masks and mistaking any process deviation as a wafer level defect.

### BACKGROUND OF THE INVENTION

1. Field of the Invention

The present invention relates to a method for detecting wafer level defect, and more particularly to a method for detecting wafer level defect by die-to-aerial image comparison.

2. Description of the Related Art

Wafer level defect inspection for IC industry is important since it is the matter of yield ratio and production cost. Current wafer level defect inspection methodologies include die-to-die inspection methods and die-to-database inspection methods. The die-to-die inspection method comprises performing an automated optical inspection of the completed reticle to search for unwanted defects on the photo mask by comparing images of the photo mask from the optical inspection system to the image from an exactly replicated pattern elsewhere on the photo mask. The die-to-database inspection method comprises performing an automated optical inspection of the completed reticle to search for unwanted defects on the photo mask by comparing images of the photo mask from the optical inspection system to the design database.

The die-to-die inspection method can provide an inspection result with a high sensitivity but always miss repeating mask defects unfortunately. On the contrary, the die-to-database inspection method can find repeating mask defects but lack sensitivity. Moreover, the die-to-database inspection method usually presents false defect inspection results due to various process deviations and the applications of phase shifting masks (PSM) and optical proximity effect correction (OPC).

In recent years, phase shifting masks (PSM) have been developed to improve photolithographic processes. Phase shifting masks increase image contrast and resolution without reducing wavelength or increasing numerical aperture. These masks also improve depth of focus and process latitude for a given feature size.

With phase shift photolithography, the interference of light rays is used to overcome the problems of detraction and improve the resolution and depth of optical images projected onto a target. With this technology, the phases of the exposure light at the target is controlled such that adjacent bright areas are preferably formed 180 degree out of phase with each other. Dark regions are thus produced between the bright areas by destructive interference even when detraction would otherwise cause these areas to be lit. This technique improves total resolution at the target.

Another method that has been developed to produce masks for use in the fabrication of semiconductors containing small features is optical proximity effect correction (OPC). In this method, changes are made to the binary mask's layout so that it will print more clearly. Because of the limited resolution of the current photolithographic tools (i.e., steppers), the patterns defined on the photo mask are transferred into the photoresist on the wafer with some distortions referred to as optical proximity effects. The main consequences in term of line width control are: corner rounding, difference between isolated and semi-isolated or dense patterns, lack of critical dimension linearity or where small features print even smaller than their expected size compared to large features, and line end shortening where the length of a line having a small line width becomes smaller than its expected size.

Moreover, optical proximity effects are convoluted with subsequent processing step distortions like resist processing, dry etch proximity effects and wet etch proximity effects. In order to achieve a sufficient line width control at the wafer level, the mask designs are corrected for proximity effects, namely re-entrant and outside serifs are used to correct rounding and the edges of the patterns are moved to correct line width errors. Another technique consists in adding small, non-printing features, referred to as subresolution features, in order to correct line width errors. In some cases, these features can also improve the process latitude of the printed resist patterns.

FIG. 1 shows a die image with line 102 with corner rounding, line 106 with corner rounding, shortening and a defect 104. If the defect 104 is generated by a photo mask defect, then the defect 104 will present repeatedly and the die-to-die inspection method would fail. FIG. 2 shows a pattern of optical proximity effect correction 202 and a line pattern 204 established in databases. The process deviations such as shortening, corner rounding will be mistook as photo mask defects. Furthermore, if the OPC and PSM technologies are utilized, databases would be too complicated and render the die-to-database inspection method much more difficult to be performed. Therefore, it is desirable to provide a new wafer level inspection method since the conventional die-to-die and die-to-database inspection methods are short of complete capability.

### SUMMARY OF THE INVENTION

It is therefore an object of the invention to provide a method for detecting wafer level defect with high sensitivity of defect inspection.

It is another object of this invention to provide a method for detecting wafer level defect that is suitable for various process deviations.

It is a further object of this invention to provide a method for detecting wafer level defect that still can be effectively performed when optical proximity effect correction (OPC) and phase shifting masks (PSM) technologies are utilized.

To achieve these objects, and in accordance with the purpose of the invention, the invention provide a method for detecting wafer level defect. The method comprises the following steps. First of all, a die image provided. Then a simulation aerial image is generated by using a pattern in a database used to form a photo mask utilized to form the die image in a photolithography process. Finally, the die image is compared with the simulation aerial image.

It is to be understood that both the foregoing general description and the following detailed description are exemplary and explanatory only and are not restrictive of the invention, as claimed.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a die image with lines and a defect;

FIG. 2 shows a pattern of optical proximity effect correction and a line pattern established in databases; and

FIG. 3 shows an example of simulation aerial image having line aerial images of this invention.

### DESCRIPTION OF THE PREFERRED EMBODIMENT

It is to be understood and appreciated that the method described below do not cover a complete system and method. The present invention can be practiced in conjunction with various software and hardware that are used in the art, and only so much of the commonly practiced components and steps are included herein as are necessary to provide an understanding of the present invention.

The present invention will be described in detail with reference to the accompanying drawings. It should be noted that the drawings are in greatly simplified form.

To understand the methodology of the invention, one must first have a basic understanding of the “process window” for lithographically printing a feature. The process window for a given feature is the amount of variation in the process that can be tolerated while still maintaining critical aspects of that feature within accepted tolerances from their desired values. In lithography, the process window is normally stated by the amount of focus and exposure dose variation that can be tolerated while maintaining feature sizes and critical dimensions (CD) within a given tolerance of their nominal values.

Process windows are typically found by either taking CD measurements on wafers that have been exposed at various focus and exposure conditions or by computing the CD from through-focus intensity profiles. In the latter case, the exposure dose can effectively be varied by changing the intensity value at which the CD is measured. These intensity profiles are typically generated either by simulation or by recording through an aerial image measurement system (AIMS) that emulates the lithography exposure conditions. The AIMS typically consists of a microscope that has a numerical aperture and illumination conditions that emulate the lithography exposure conditions. This system records the aerial image, or the image of the photo mask that is projected onto the photoresist by the lithography exposure tool.

The invention provides a method for detecting wafer level defect by comparing die images to simulation aerial images. As described in the background of this invention, the die-to-die inspection and the die-to-database inspection methods each have their own blind spots. The die-to-die inspection cannot find repeating defects induced by photo mask defects since either of two die images being compared have the same defects which cannot be found by comparison. On the contrary, the die-to-database inspection method might recognize the repeating defects induced by photo mask defects since the pattern image in the database should not be defective. However, the die-to-database inspection method usually mistakes deviations induced by process as wafer level defects. The most common process deviations are corner rounding and line end shortening phenomena. As mentioned in the background of this invention, the corner rounding presents some difference between isolated and semi-isolated or dense patterns, and lack of critical dimension linearity. The shortening shows a line having a length smaller than its expected size.

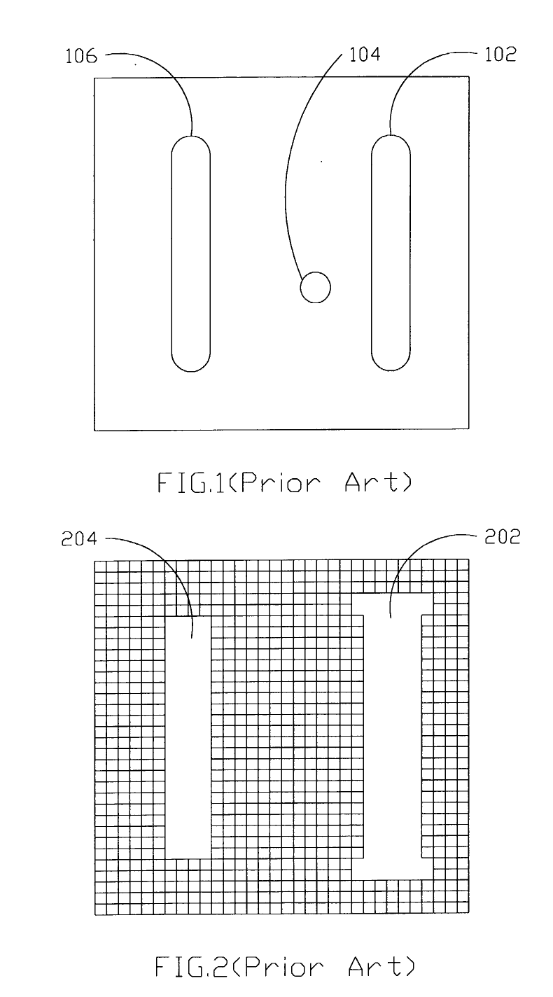

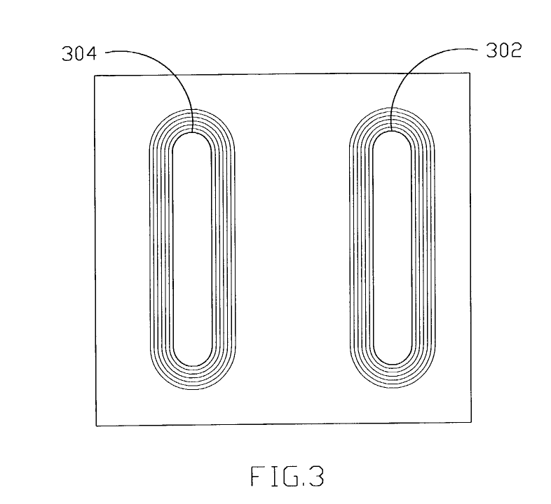

It is well known that there are functional dependencies of feature size versus focus and exposure dose. To find out defects in a die image, the invention uses patterns in database to simulate and generate aerial image by setting lithography parameters such as focus, wavelength and exposure dose. For example, one can utilize the pattern shown in FIG. 2 to simulate an aerial image of optical proximity effect correction or a simulation die image produced by simulating a photolithography process with phase shifting masks. By setting real exposure parameters, all process deviations would appear in the simulation aerial image. Repeating defects of die images would not show in the simulation aerial image since the patterns in database used to generate the simulation aerial image are definitely perfect. By comparing the die image with the simulation aerial image, the repeating defects induced by photo masks would be discovered. When optical proximity effect correction or phase shifting masks are used, simulation aerial images would present photolithography results correspondent with optical proximity effect correction or phase shifting masks by setting appropriate exposure parameters. FIG. 3 shows an example of simulation aerial image having line aerial images 302 and 304. Both the line aerial images 302 and 304 show corner rounding phenomena while the line aerial image 304 also presents a shortening effect. The repeating defect 104 shown in FIG. 1 can be found by comparing the die image in FIG. 1 and the simulation aerial image in FIG. 3. Moreover, the corner rounding of the lines 102 and 106 and shortening phenomena of the line 106 in FIG. 1 would not be recognized as wafer level defects. By comparing die images with simulation aerial images of optical proximity effect correction or phase shifting masks, process deviations appeared in both real and simulated images would not be treated as wafer level defects.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claim is:

1. A method for detecting wafer level defect, said method comprising:
providing a die image;
generating a simulation aerial image by using a pattern in a database used to form a photo mask utilized to form said die image in a photolithography process; and
comparing said die image with said simulation aerial image.

2. The method according to claim 1, wherein said simulation aerial image is generated by setting focus, wavelength and exposure dose.

3. The method according to claim 1, wherein said simulation aerial image comprises an aerial image of optical proximity effect correction.

4. The method according to claim 1, wherein said photo mask comprises a phase shifting mask.

5. A method for detecting wafer level defect, said method comprising:
providing a die image;
generating a simulation aerial image of optical proximity effect correction by using a pattern in a database used to form a photo mask utilized to form said die image in a photolithography process; and
comparing said die image with said simulation aerial image.

6. The method according to claim 5, wherein said simulation aerial image of optical proximity effect correction is generated by setting focus, wavelength and exposure dose.

7. A method for detecting wafer level defect, said method comprising:
providing a die image;
generating a simulation aerial image by using a pattern in a database used to form a phase shifting photo mask utilized to form said die image in a photolithography process; and
comparing said die image with said simulation aerial image.
